(19) United States
(12) Patent Application Publication
(10) Pub. No.: US 2014/0215284 A1
(43) Pub. Date: Jul. 31, 2014

(54) DYNAMIC SCALING PROCESSOR DEVICE AND PROCESSING METHOD THEREOF

(71) Applicant: National Chung Cheng University, Min-Hsiung (TW)

(72) Inventors: Tien-Fu CHEN, Min-Hsiung (TW); Shu-Hsuan CHOU, Min-Hsiung (TW); Po-Hao WANG, Min-Hsiung (TW); Yung-Hui YU, Min-Hsiung (TW)

(73) Assignee: National Chung Cheng University, Min-Hsiung (TW)

(21) Appl. No.: 13/960,317

(22) Filed: Aug. 6, 2013

(30) Foreign Application Priority Data
Jan. 25, 2013 (TW) 102102883

(51) Int. Cl. G06F 11/14

(52) U.S. Cl. CPC G06F 11/1497
USPC 714/746

(57) ABSTRACT

A dynamic scaling processor device and processing method thereof, having a timing decoder, a multi-cycle controller, a correction flip-flop. The timing decoder is provided with a plurality of cycles therein, to receive a plurality of instructions, to select corresponding cycles as its predetermined cycles based on type of each instruction, and output the predetermined cycles and its corresponding instructions to the multi-cycle controller. The multi-cycle controller computes results of the instructions based on the predetermined cycles or a single cycle, and outputs them to the correction flip-flop. The error detection flip-flop utilizes a first clock signal and a stalled second clock signal, to sample a same result, and correct the results when outcomes of samplings are different.

### BACKGROUND OF THE INVENTION

1. Field of the Invention

The present invention relates to a processor technology, and in particular to a dynamic scaling processor device and processing method thereof.

2. The Prior Arts

In recent years, the emergence of the Green Energy Industries has brought about the advance of related science and technology. Also, the emphasis on solar cell development indicates that, the increasingly serious energy crisis is getting more and more attentions. In this respect, the developments mentioned above have brought impact to the existing IC design technology. Therefore, how to maintain adequate effectiveness and performance in a low operation power environment (for example, solar cell, mercury cell power supply) has become a great challenge. In addition, in our daily life, the need for portable electronic devices has increased significantly, thus leading to the development of biomedical electronics, and intelligent handsets integrating business and entertainment functions.

In order to meet various demands, the design of embedded system is getting more complicated, such that high speed computation can not only lead to large amount power consumption, but the heat generated could also adversely affects system stability and performance. By way of example, more and more multi-media applications are put into the mobile phone handset. Among them, the various functions, such as Blue Tooth and Wireless Transmission require power to operate. In this respect, due to the limited power supply capability of a battery, power management and conservation for a system on chip (SOC) plays a very important role.

With regard to power consumption, refer to the following Equation (1). Wherein, energy consumption is positively proportional to frequency (f), number of instructions (N) executed, square of power supply voltage (V), and is inversely proportional to the square of Instructions Per Cycle (IPC). Therefore, in order to reduce power consumption, it is essential to create a low voltage operation environment to achieve low power consumption.

$$Energy ∝ f \cdot {V}^{2} \cdot t ∝ f \cdot {V}^{2} \cdot ( \frac{N}{f \cdot I P C} ) ∝ \frac{{V}^{2}}{I P C} \qquad ( 1 )$$

As mentioned above, operation voltage reduction is essential to the decrease of power consumption. However, in a conventional design, a stable voltage is required for system operation. As such, when voltage is drifted due to noise factor, the entire circuit is affected, with the circuit speed slows down, or even more seriously, the operation of the entire circuit will be paralyzed. Therefore, how to handle power supply variations is an important task to be accomplished. From the design based on nominal voltage, to the design based on low voltage, sub-threshold voltage, and ultra-low voltage, which constitute a series of challenges of increasing difficulties. Therefore, quite a lot of researches, such as dynamic voltage scaling (DVS) suitable for use in ultra-low voltage circuit design, Timing Error Detection in low voltage environment, etc., have all dedicated to solve the problem of low voltage and large environment variations, while trying to keep the original performance.

Circuit area reduction is another solution to this problem. The magnitude of capacitance, namely the amount of power consumed is related to size of circuit area. The progress of manufacturing process has provided solution to the problem of circuit area size, but it also brings about the problem of IC delay and heat dissipation. In 2007, the system on chip (SOC) Road map (SOC Roadmap) of the International Technology Roadmap for Semiconductors (ITRS) predicted that, in 2012 the limit of semiconductor manufacturing process can reach below 22 nm, while the transistor density can reach 3.2×10¹⁰ transistors/cm².

From the view point of manufacturing process, the trend of size reduction will continue. Also, based on the degree of integration, the increase of complexity will make wire delay greater than logic delay in the Integrated Circuit (IC), such that low power consumption, and tolerance of manufacturing process and operation environment variations has become a critical issue of IC design. Along with the decrease of circuit area, heat dissipation requirement inside the chip has increased significantly. According to a recent research report, a 60% length reduction would require 6-fold increase of heat dissipation (W/cm²). Meanwhile, from the equation of power consumption≈capacitance×voltage of power supply×2 clock frequency+power supply voltage×leakage current, it can be known that, the crux of effectively improving power consumption is to control power supply voltage and clock frequency. Since the low voltage circuit design is a trend of the future, and due to increase of process precision, such that IC design of low power consumption can be realized, and that is indispensable in the design of industrial products. However, the non-linear delay increase and large variations brought about by low voltage have still to be overcome. In the trend of developing the embedded processor, the performance and stability of processor are apparently affected by the decrease of voltage, such that new variation-tolerant technology or an adaptable pipeline control design must be arranged in cooperation to raise or compensate for the decrease of performance. Meanwhile, as mentioned above, the precision and variations of manufacturing process are essential to the IC design. By way of example, in the manufacturing process of a 90 nm transistor, the variation of frequency is about 30%, and this deficiency could cause increased difficulty in IC design. Consequently, the solution to the timing variation and on-chip reliability problem is an urgent task that has to be solved in this field.

Therefore, presently, the design and performance of processor and processing method thereof is not quite satisfactory, and it has much room for improvements.

### SUMMARY OF THE INVENTION

In view of the problems and drawbacks of the prior art, the present invention provides a dynamic scaling processor device and processing method thereof, to overcome the problems and drawbacks of the prior art.

A major objective of the present invention is to provide a dynamic scaling processor device and processing method thereof. Wherein, a timing decoder is used to convert statically a variable delay into a variable cycle, and an error detection flip-flop is used to perform detection, to reduce the safety margin of dynamic voltage and frequency scaling, hereby raising data throughput, reducing power consumption and process variations.

In order to achieve the above mentioned objective, the present invention provides a dynamic scaling processor device, comprising: a timing decoder, a multi-cycle controller, and a correction flip-flop. Wherein, the timing decoder is provided with a plurality of cycles, to receive a plurality of instructions, and to select corresponding cycles as its predetermined cycles based on the type of each instruction, and output the predetermined cycles and its corresponding instructions. The multi-cycle controller is connected to the timing decoder, to receive the instructions and the predetermined cycles. The multi-cycle controller executes the instructions based on the predetermined cycles or a single cycle, and outputs its results. The error detection flip-flop is connected to the multi-cycle controller to receive the result, a first clock signal, and a second clock signal lagging behind half a cycle. The error detection flip-flop utilizes the first clock signal and the second clock signal, to sample a same result, and correct the result when the outcomes of samplings are different.

The present invention also provides a dynamic scaling processing method, comprising the following steps: Firstly, receive a plurality of instructions, to select corresponding cycle as its predetermined cycle based on type of each instruction, and output the predetermined cycle and its corresponding instruction. Next, utilize a multi-cycle controller to receive the instruction and the predetermined cycle, to determine whether to execute a fast channel based on computed value of the instruction. In case the reply is affirmative, use a single cycle to perform the instructions to obtain a first answer; or otherwise, use the predetermined cycle to perform the instruction to obtain a second answer. Then, utilize the first answer or the second answer as the result of performing the instruction, and output the result. Finally, receive the result, the first clock signal and the second clock signal lagging behind half a cycle, utilize the first clock signal and the second clock signal to sample a same result, and correct the result when the outcomes of samplings are different.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from this detailed descriptions.

### BRIEF DESCRIPTION OF THE DRAWINGS

The related drawings in connection with the detailed descriptions of the present invention to be made later are described briefly as follows, in which:

FIG. 1 is a circuit diagram of a Razor flip-flop according to the prior art;

FIG. 2 is a waveform diagram of signals generated by the Razor flip-flop of FIG. 1;

FIG. 3 is a schematic diagram of a dynamic scaling processor device according to the present invention;

FIG. 4 is a flowchart of the steps of dynamic scaling processing method according to the present invention;

FIG. 5 is a waveform diagram of signals generated by GPP-ULV-RISC according to the present invention;

FIG. 6 is a flow chart of the steps of developing GPP-ULV-RISC according to the present invention;

FIG. 7 is a circuit diagram of an error detection flip-flop according to the present invention; and

FIG. 8 is a circuit diagram of execution stage restructuring a variable delay path according to the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

The present invention is applicable to the vanguard and rearguard timing protection mechanism of a dynamic scaling voltage processor, capable of reducing safety margin under the worst condition, to achieve reliably better performance with reduced power consumption. Firstly, a timing decoder is used to convert statically a variable delay into a variable cycle, to correct the over-safety margin for most of the data paths. Wherein, it utilizes structure level timing partition, variable cycle delay control of low overhead, and experiment of throughput. Since low voltage could accelerate worsening of delay in this condition, to result in inferior performance and highlight the effects of variable cycle delay. Secondly, a timing error detection rearguard is used, to reduce further the safety margin for the dynamic voltage and frequency scaling, and to tolerate further lower voltage scaling. Therefore, compared with conventional design of dynamic voltage and frequency scaling, the approaches just mentioned could have the original computation capability, lower power consumption, and greater data throughput, while mitigating the performance degradation problem of significant increase of critical path computation time caused by low voltage, while effectively reducing process variations.

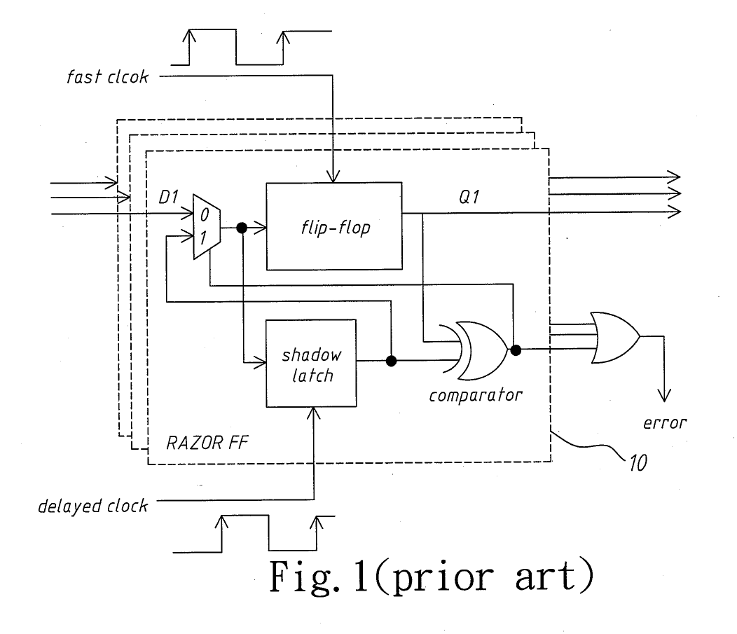

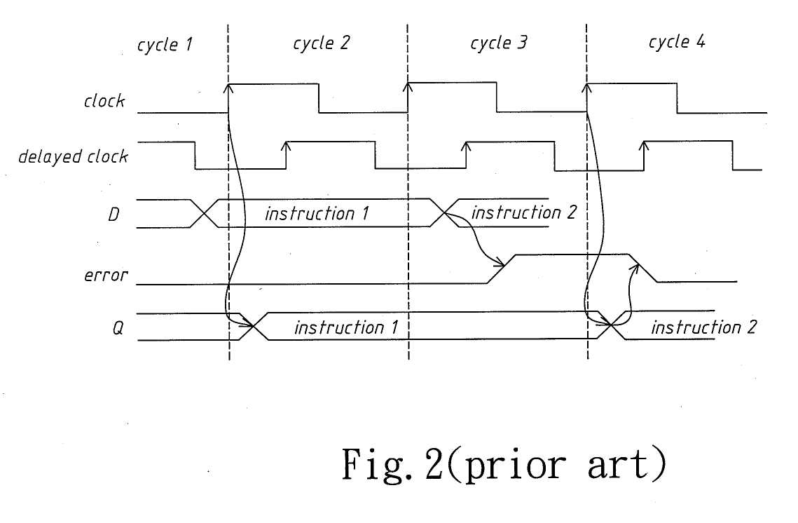

Before explaining the framework of the present invention, A Razor flip-flop is first described. Refer to FIGS. 1 and 2 respectively for a circuit diagram of a Razor flip-flop according to the prior art, and a waveform diagram of signals generated by the Razor flip-flop of FIG. 1. As shown in FIGS. 1 and 2, the basic concept of Razor flip flop is to observe the error rate of a processor operating at a certain voltage, to adjust the processor to a voltage of best energy consumption through adjusting its operating voltage, and timely correct errors occur during computations. In this respect, a Razor flip-flop 10 is an important element proposed by Razor to detect computation error, and that will perform detections twice for value of the pipeline stage. Then, it will be driven by two independent clocks respectively, a fast clock and a delay clock. Wherein, the delay clock is the driving signal used by Razor technology to compute and obtain the correct results. When this delayed clock is received, the Razor flip-flop 10 will compare it with the previous computation results. In case the two results are different, that means the computation results obtained through driving by the fast clock is in error. At this time, the Razor flip-flop 10 will send out an error message, and activate mechanism to recover the correct data.

The present invention is based on “a pipeline scaling technology” to analyze the pipeline execution time, relative to the “instruction and data type” and the frequency used, and it utilizes a synthesis technology to make the execution time controllable. When “a dynamic scaling pipeline delay technology” is added, the execution time prediction circuit can predict and control the pipeline execution time, and divide it into a plurality of different cycles based on the instruction and data type, so that the processor clock pulse will not be restricted to the worst circuit delay. Therefore, the overall performance can be raised. When comparing the environment variations with the timing error of the existing detection technology (for example, Razor), the execution time prediction can not guarantee completely its correctness, the problem of potential timing error may still exist. Therefore, the present invention constructs an ultra-low cost correction flip-flop, to ensure correctness of execution. In addition, the debugging element can not only detect the potential errors, but it can also allow the prediction circuit to predict aggressively the execution time, to reduce the cycles required to the minimum.

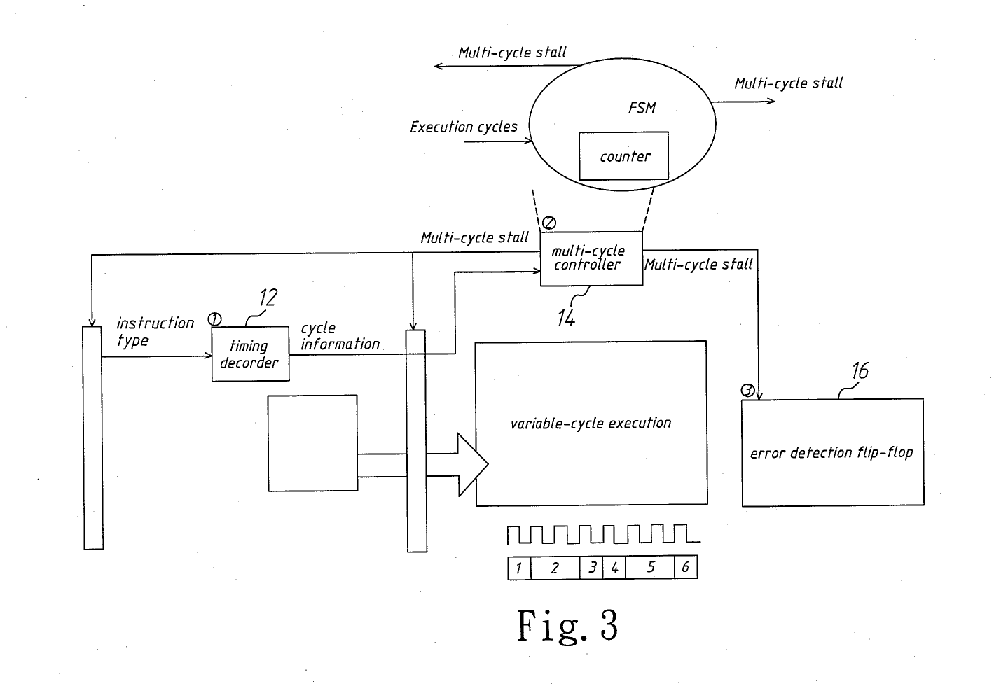

Then, refer to FIG. 3 for a schematic diagram of a dynamic scaling processor device according to the present invention. The present invention is provided with a timing decoder 12, that is capable of storing a plurality of cycles. The timing decoder 12 is able to receive a plurality of instructions, to select the corresponding cycles as its predetermined cycles based on the type of each instruction, and output the predetermined cycles and its corresponding instructions. Due to the application of “the pipeline scaling technology”, the execution cycles required by the respective instructions to enter into execution stage are different. For example, the multiplication of 32-bit would require 3 cycles.

The timing decoder 12 is connected to a multi-cycle controller 14, that includes a finite state machine (FSM), to receive the instructions and the predetermined cycles, and utilize a single cycle or the predetermined cycles to execute the instructions and output its results. In order to raise the performance more aggressively, the present invention raises the frequency to shorten the cycle, so that it may have maximum throughput and increased tolerance. However, this may lead to the results that execution time of some of the instructions exceeds the cycle time.

The finite state machine (FSM) of the multi-cycle controller 14 is connected to an error detection flip-flop (FF) 16, to receive the results mentioned above, and to receive the first clock signal and the second clock signal lagging behind half a cycle. The error detection flip-flop 16 is exemplified by the Razor flip-flop. The error detection flip-flop 16 samples the same result with the first clock signal and the second clock signal. When the outcomes of the samplings are different, it will install one cycle, to allow the recovery mechanism in error detection flip-flop (FF) 16 to compute the correct answer, to correct the result and continue execution. In addition, the timing decoder 12 further includes a plurality of registers to store cycles, and provide them for use in external corrections as required.

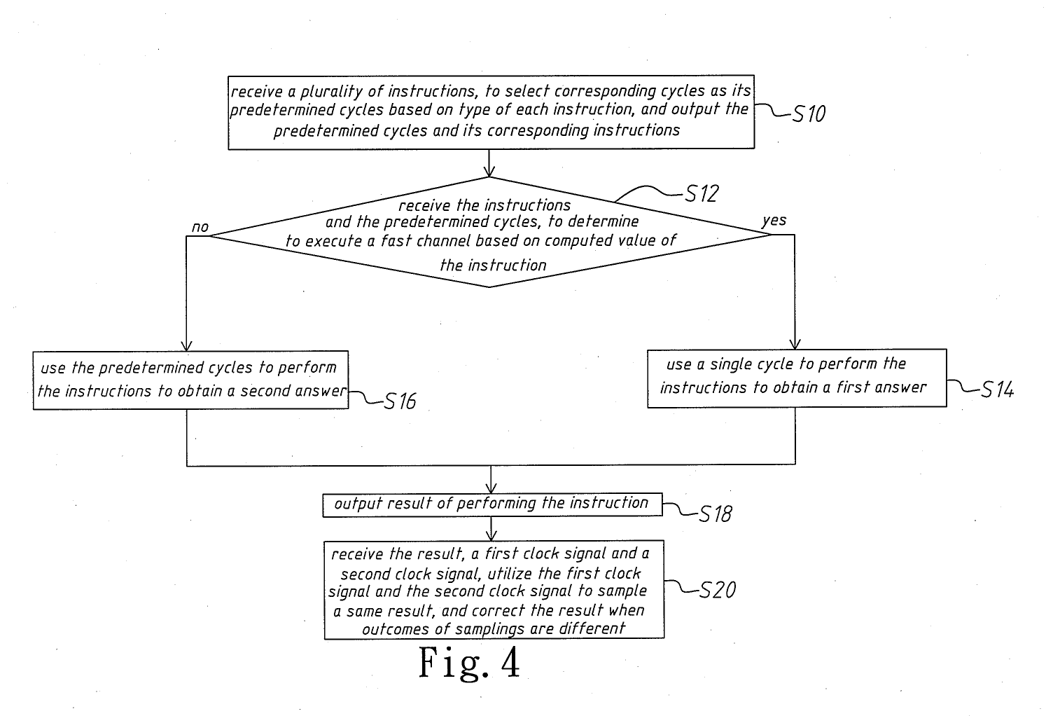

Subsequently, refer to FIG. 4 for a flowchart of the steps of dynamic scaling processing method according to the present invention. Also, refer to FIG. 3 at the same time. Firstly, as shown in step S10, a timing decoder 12 receives a plurality of instructions, to select the corresponding cycle as its predetermined cycle based on the type of each instruction, and output the predetermined cycles and its corresponding instructions. Next, as shown in step S12, the multi-cycle controller 14 receives the instruction and the predetermined cycle, to determine whether to execute a fast channel based on computed value of the instruction. In case the reply is affirmative, then, as shown in step S14, use a single cycle to execute the instructions to obtain a first answer; or otherwise, as shown in step S16, use said predetermined cycles to execute the instructions to obtain a second answer. After completion of steps S14 and S16, perform step S18, utilize the multi-cycle controller 14 to output the first answer and the second answer as the result of instruction execution. Finally, as shown in step S20, the error detection flip-flop 16 receives the result mentioned above, the first clock signal, the second clock signal lagging behind half a cycle, to sample a same result with the first clock signal and the second clock signal, and when the sampled outcomes are different, correct the result.

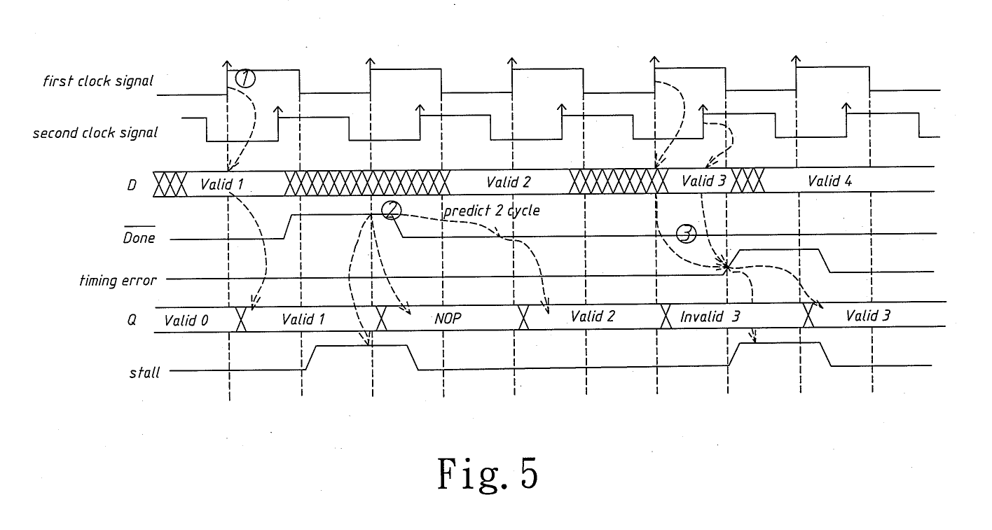

Then, refer to FIG. 5 for a waveform diagram of signals generated by GPP-ULV-RISC according to the present invention. Wherein, at (1) it indicates that under the normal execution condition, upon triggering the first clock signal, it (D in FIG. 5) is transmitted to the next stage (Q) through the Razor pipeline. At (2) it indicates that, the next instruction is predicted to execute 2 cycles, such that a stall signal is issued. At this time, no result is produced in Razor pipeline, the value of Q is NOP. At (3), the first clock signal and the second clock signal are triggered separately, the result of comparison in the Razor pipeline is different. Therefore, a timing error signal is issued, so that the result of Q is invalid. The recovery mechanism will issue a stall signal, to borrow another cycle to complete the execution. As such, it can be known that the multi-cycle mechanism and time prediction error could affect its throughput. Therefore, how to achieve balance between cycle time and cycle number is an issue worthy of investigation.

The instruction delay can be shortened or lengthened due to variations of voltage, temperature, or other environment factors. Presently, frequency scaling is a popular solution related to recover the functions lost due to variation tolerance. Since the extent of tolerance is quite set up at the circuit level, such that it is less flexible when making tradeoff between performance and variation tolerance. However, with regard to variation tolerance, a multi-cycle design can be used, that is completely different from the conventional design. To the short cycle time and the arranged execution cycle, the effect of multi-cycle execution time design is very close to that of delay. Table 1 below shows the various multi-cycle execution stages based on instruction type and the stall analysis mentioned above. According to the statistical data of Embedded Microprocessor Benchmark Consortium (EEMBC) standard and media standard, the average utility rate in Table 1 indicates the compositions of various delay instructions, thus providing ways to improve the multi-cycle design.

TABLE 1

| | | | | Initial | CTS multi- | | |
|---|---|---|---|---|---|---|---|
| | | | Baseline | Multi- | Cycle @ | | |
| | | | @112M | Cycle | 166M Hz | | |
| Instruction/Data type/AVG Usage | | | Hz | @116 Hz | worst | AVG | best |
| Trivial | A′au_op′0, | 5.4% | — | — | 1 | 1 | 1 |
| operation | A*1, A*0, | | | | | | |
| | Condition- | | | | | | |
| | test-fail | | | | | | |
| Branch | — | 10.0% | 1 | 1 | 1 | 1 | 1 |
| (LS/LSM) | with | 4.4% | 1 | 2 | 2 | 1 | 1 |
| | shifter | | | | | | |
| | with logic shift | 2.0% | | | 1 | 1 | 1 |
| | left (LSL) 0~7 | | | | | | |
| | without | 32.0% | 1 | 1 | 1 | 1 | 1 |
| | shifter | | | | | | |
| Arithmetic | with | 0.5% | 1 | 2 | 2 | 2 | 1 |
| | shifter | | | | | | |
| | with | 9.5% | | | 2 | 1 | 1 |
| | LSL 0~7 | | | | | | |
| Arithmetic | with shifter | 4.5% | | | 2 | 1 | 1 |
| without | with | 2.1% | | | 1 | 1 | 1 |
| Nzcv update | LSL 0~7 | | | | | | |
| | without | 10.6% | | | 1 | 1 | 1 |
| | shifter | | | | | | |
| logic | with | 6.2% | 1 | 1 | 1 | 1 | 1 |
| | shifter | | | | | | |
| | with | 2.9% | | | 1 | 1 | 1 |
| | LSL 0~7 | | | | | | |
| | without shifter | 11.4% | | | 1 | 1 | 1 |
| multiply | 8 × 8 | 0.8% | 2 | 2 | 2 | 1 | 1 |
| add command | 16 × 8 | 1.1% | | | 2 | 1 | 1 |
| (MAC) | 16 × 16 | 0.6% | | | 2 | 2 | 1 |
| | 32 × 32 | 1.4% | | | 2 | 2 | 1 |
| | 32 × 32 + 64 | 0.0% | | 3 | 3 | 2 | 2 |

The instruction/data in Table 1 can be classified into two categories: baseline and course-grain timing speculation (CTS) multi-cycles, and based on data route, CTS can not be performed. The baseline is only a preliminary classification stage, so that all the instructions can be executed in sequence. For example, a MOV instruction can pass through a shifter unit without taking actions, to reach a logic unit. On the other hand, the data path of a CTS multi-cycle can be classified more specifically, such as the arithmetic instruction can be classified into 5 sub-categories. Even more, it will take into consideration of operation values. Therefore, the length of path delay can be more different, thus requiring more cycles. The baseline classification is taken as an example, when the frequency reaches 112 MHz, through the result of synthesis, in addition to multiplication, the delay time for instructions of various types is limited to within 9 ns. Therefore, nearly 96% instructions can be performed in a pipelining way, hereby requiring only one cycle to finish execution; while the multiplication instruction requires an additional cycle to prevent system error. In order to be more efficient, the subject frequency is raised to 166 MHz. At this time, the duration of one cycle, and the delay duration for most one-cycle type instructions will get close. But, after scaling, the instruction type of longer delay duration: LS/LSM and the arithmetic instruction may not be able to finish computing. Then, the execution cycle is lengthened to 2 cycles, such that this may lead to an average 33% performance loss (depending on the application program), but it can raise frequency of classification instructions.

There are three standards to classify CTS multi-cycles: worst, average, and best. The ways of definition is depending on operation environment (worst: 0.45V, 125° C.; average: 0.5V, 25° C.; best 0.55V, 0° C.). In the worst environment, a conservative classification of the initial multi-cycle has few variations. In the conditions without any frequency variations, CTS is improved 13%. In a better environment, such as in an average and a best environment, an additional 18% cycles can be saved. Moreover, for almost all types of instructions, the execution cycle frequency is 166 MHz. Upon discovering environment variations, the CTS multi-cycle design can be used to rearrange cycle time, to tolerate a worsening environment, or to operate at higher speed in the best environment.

The Branded Timing Speculation (BTS) includes a multi-cycle mechanism and a timing error detector, and it tries to increase the frequency to 250 MHz. Then, the multi-cycle classification rearranges a 4 ns cycle time. In order to obtain better performance, the execution cycle may not be always as conservative as CTS. In an error occurring event, data recovery will stop the pipeline operation a cycle temporarily, so that the instruction may have sufficient time to execute operation has yet to be finished. By way of example, the longest route for a Logic Shift Left (LSL) instruction to pass through an arithmetic unit would require 5.15 ns. In this case, at 250 MHz, if CTS is utilized, the execution cycle is 2 cycles; yet if BTS is used, only one cycle is required. Since not every instruction of this type requires 5.15 ns to perform, such that if 80% instructions of this type require less than 4 ns to obtain results, then the remaining 20% must utilize additional overhead to execute. Therefore, when the operation frequencies are the same, in average, BTS requires 1.2 times the cycle time to execute instructions, while CTS utilizes 2 times the cycle time to perform instructions.

Table 2 shows the classifications and differences of CTS and BTS, operated at different target frequencies. In these classifications, from CTS to BTS, the increase of frequency creates certain overhead. For the worst environment variations, there are an average 5% overhead. Yet the raised BTS can offset the overhead. Since the protection offered by FTS exceeds the loss caused by executing instructions, some of the BTS instruction types keep the cycle time created in a typical environment of CTS. Meanwhile, in the best condition, for the instructions of execution time exceeding 4 ns, the safety margin can be eliminated to save more power. Summing up the above, when CTS is transformed to BTS, their classifications are slightly different. However, since the frequency is increased to 250 MHz, its performance is remarkably improved.

TABLE 2

| | | | CTS@166M Hz and BTS@250M Hz | | | | | |
|---|---|---|---|---|---|---|---|---|
| | | | worst | | average | | best | |
| Instruction/Data type/AVG Usage | | | CTS | BTS | CTS | BTS | CTS | BTS |
| Trivial operation | A′au_op′0, A*1, | 5.4% | 1 | 1 | 1 | 1 | 1 | 1 |
| | A*0, | | | | | | | |
| | Condition- | | | | | | | |
| | test-fail | | | | | | | |
| Branch | — | 10.0% | 1 | 1 | 1 | 1 | 1 | 1 |
| LS/LSM | with | 4.4% | 2 | 2 | 1 | 1 | 1 | 1 |
| | shifter | | | | | | | |
| | with | 2.0% | 1 | 2 | 1 | 1 | 1 | 1 |
| | LSL 0~7 | | | | | | | |
| | without | 32.0% | 1 | 1 | 1 | 1 | 1 | 1 |
| | shifter | | | | | | | |
| Arithmetic | with | 0.5% | 2 | 2 | 2 | 2 | 1 | 1 |
| | shifter | | | | | | | |
| | with | 9.5% | 2 | 2 | 1 | 1 | 1 | 1 |
| | LSL 0~7 | | | | | | | |
| Arithmetic w/o | with | 4.5% | 2 | 2 | 1 | 1 | 1 | 1 |
| nzcv update | shifter | | | | | | | |
| | with | 2.1% | 1 | 2 | 1 | 1 | 1 | 1 |
| | LSL 0~7 | | | | | | | |
| | without | 10.6% | 1 | 1 | 1 | 1 | 1 | 1 |
| | shifter | | | | | | | |
| logic | with | 6.2% | 1 | 1 | 1 | 1 | 1 | 1 |
| | shifter | | | | | | | |
| | with | 2.9% | 1 | 1 | 1 | 1 | 1 | 1 |
| | LSL 0~7 | | | | | | | |
| | without | 11.4% | 1 | 1 | 1 | 1 | 1 | 1 |
| | shifter | | | | | | | |
| MAC | 8 × 8 | 0.8% | 2 | 2 | 1 | 1 | 1 | 1 |
| | 16 × 8 | 1.1% | 2 | 2 | 1 | 2 | 1 | 1 |
| | 16 × 16 | 0.6% | 2 | 2 | 2 | 2 | 1 | 1 |
| | 32 × 32 | 1.4% | 2 | 3 | 2 | 2 | 1 | 2 |
| | 32 × 32 + 64 | 0.0% | 3 | 3 | 2 | 2 | 2 | 2 |

In the present invention, the process flow of a method is utilized, to carry out development from high level to low level, and to realize it in a low cost processor. The key point of this process flow is to make the design of variable length execution more flexible and accurate, and be more tolerant to process variations, so that the whole design is more workable and endurable. Compared with the process flow of the conventional design, the combined process flow of the present invention includes two new processes, comprising: (1) in various environments (for example, worst/average/best), optimize various data paths statically; (2) impose minimum delay constraint for fine-grained timing stealing). In order to allow processor to have better performance most of the time, in the combined process flow, analyses are made in advance. Next, in a standard environment, optimize a plurality of important data paths, then perform evaluations of the combined circuits in various environments. Though, in the best and the worst environments, unexpected longer data paths could appear, yet this problem may always exist, or it may not be solved in limited number of re-combinations. In this condition, that means the optimizations of various data paths in various environments may affect each other, and the most simple solution is to allow the less frequently used instructions to execute one more cycle.

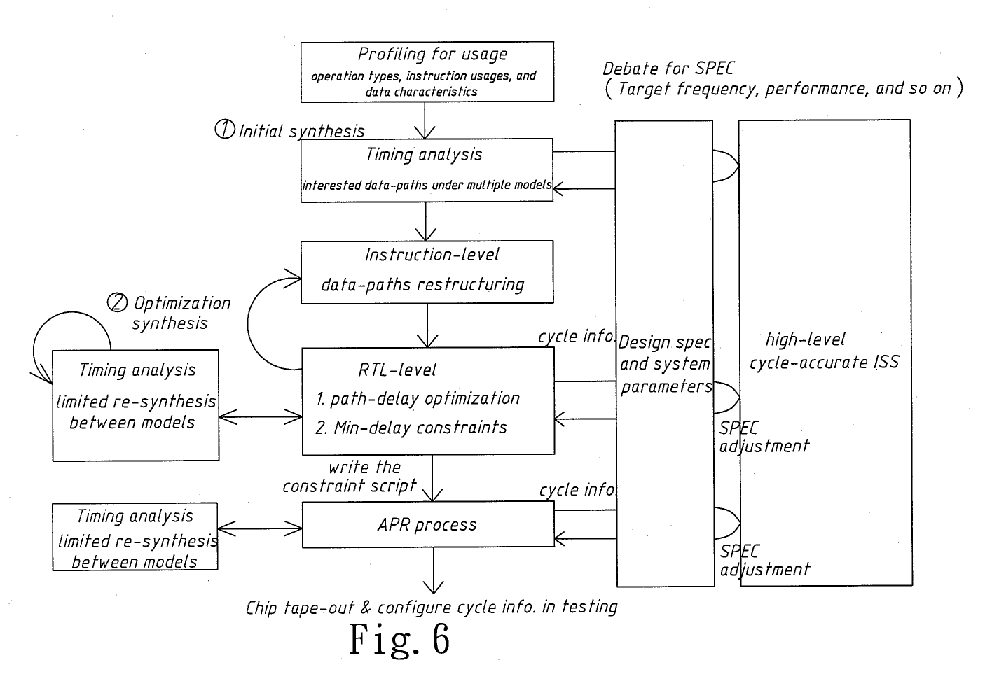

Subsequently, refer to FIG. 6 for a flow chart of the steps of developing GPP-ULV-RISC according to the present invention. Wherein, the process flow is divided into several parts, such that the operations of the processor and the data of operation are used to evaluate the utility rates of function units of various processors. Then, the results of preliminary combinations are used to provide features for the circuits of the processor, and the relations between length of circuit delay and instructions can be derived in cooperation with the preliminary utility rate. The operation value is another factor affecting the length of circuit delay. Based on the two preliminary analyses mentioned above, the adjustment of processor structure can be performed, to design a pipeline stage in cooperation with instruction level, such that its circuit execution time can be predicted. Then, try to optimize circuit of this stage with synthesis technology, so that it fulfills the predicted execution time. Through using this process flow, correct repeatedly the circuit design and its corresponding predicted time, until it fulfills the design specification of the system. Then, set up the simulator of instruction level to simulate cycle execution condition, to obtain preliminary performance evaluation in cooperation with the analyses (time, area, power) obtained. After achieving the first stage circuit design (gate level) through repeated corrections, enter into later stage (APR) circuit design and performance evaluation, to finally obtain the processor of target design. The detailed descriptions of various stages are as follows.

Timing Decoder

Cycle information is provided in the time decoder, such that the cycle information indicates how many cycles to be performed. The timing decoder can be set from outside the chip, so that it is not a register that can not be rewritten. The timing decoder has three kinds of cycle information, indicating respectively 3 execution modes the reduced instruction set computing (RISC) is in. The RISC will change execution mode, along with detection of the sensor, to adopt appropriate cycle information. When in the decoding stage, it obtains which units of the execution stage are required based on the instructions, and it assigns various cycles required based on the execution time and execution mode as required by the instructions.

Multi-Cycle Controller

The Multi-Cycle Controller includes a finite state machine (FSM), to determine if it is to execute a plurality of cycles and delay other pipelines, to prevent data overwritten of the previous stage. The finite state machine includes two stages of execution time prediction. Wherein, one is the execution cycle set by the instruction type, while the other is the execution cycle determined through value of operation. The second stage execution time prediction is mainly for detection of Trivial Operation, to determine if fast channel has to be used. Trivial Operation is realized through using operators and the related instruction types, such as A*0=0, A+0=A. Due to its characteristics of obtaining results without the need to go through operations, such that once it is detected, the predicted execution time is set to one cycle. However, in the second stage, the execution of prediction circuit must be fast, to ensure timely control. Therefore, only specific Trivial Operations must be performed.

Correction Flip-Flop

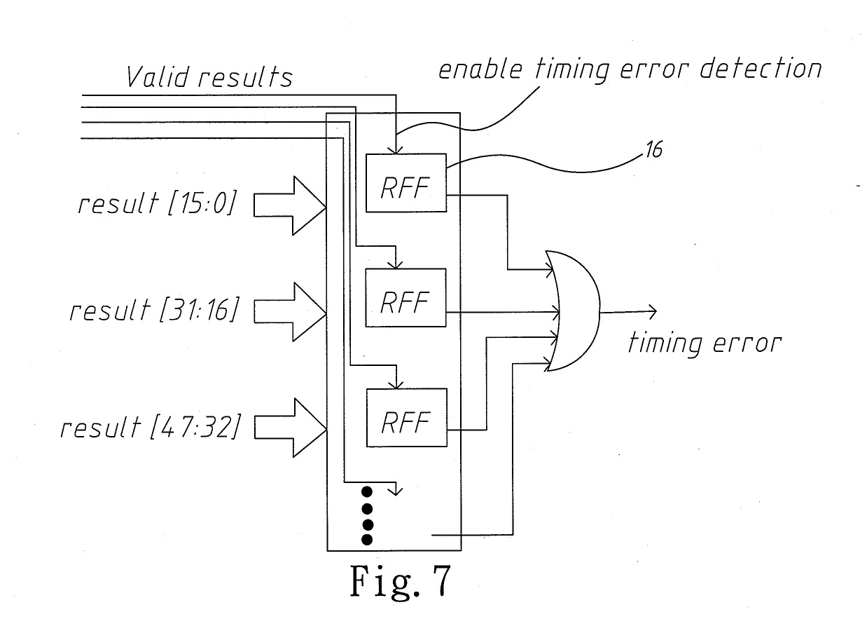

Refer to FIG. 7 for a circuit diagram for an error detection flip-flop according to the present invention. As shown in FIG. 7, the error detection flip-flop 16 replaces the pipeline after the original variable-cycle execution stage. Similar to the Razor design, in the error detection flip-flop 16 is provided with a shadow latch, it utilizes another clock pulse lagging behind half a cycle, to correct erroneous result, and it utilizes a comparator to determine if an error does occur. In the Razor design, the addition of error detection flip-flop 16 to each stage could occupy quite a lot of area. Also, the determination of erroneous results could consume quite a lot of time. In order to reduce cost, the results of comparison must be obtained at fast speed. In the present invention, the design is to use error detection flip-flop 16 to replace the original flip flop (FF). In addition, the error detection mechanism of Razor is to detect if the result of each bit is correct, such that it utilizes an OR gate to process all the erroneous signals, thus requiring quite a lot of time. In the present invention, a partial-error comparator is proposed, to compare a plurality of bits at the same time, and to check the critical comparator first, so as to effectively detect error at fast speed.

With regard to execution stage (EXE stage), the present invention proposes a pipeline restructuring technology. In contrast to the conventional approach of optimizing the bottom level circuit, the approach of the present invention is to view an adjustable processor from a higher level. The designer organize data path of the Exe Stage, through observing program behavior to indicate the potential short paths that can not be seen from the circuit level. Moreover, the results of optimization are assigned to the cycle information and embed into instruction decoder without gaps to perform timing prediction.

Firstly, for the data path that are used frequently and requiring shorter execution time, the following organization approaches are proposed, so that the multi-cycle controller can compute results of instruction in a single cycle as follows:

1. Separate the Frequently Used Operation Units:

Arithmetic logic unit (ALU) is an operation unit used most frequently, for most of the instructions must go through ALU to perform various operations. However, in the design of instruction set (utilizing ARM7TDMI), in order to save instruction numbers, shift and ALU are arranged to finish executing in a single instruction. Since for most of the instructions, ALU execution is performed along with a Shift operation, therefore, before the Operand reaches ALU, it must first go through a Shift operation. When it is found that its purpose is only to perform simple ALU operation, then, a delay of Shift Unit operation is not necessary. Therefore, through analyzing shift type and shift amount of a Shifter, the operation through the Shifter Unit can be eliminated to go directly into the ALU operation. For this reason, Shifter+ALU can be decomposed into 3 paths of different execution durations: an Arithmetic Unit (operand not requiring Shift), a Logic Unit (operand not requiring Shift), and a Shifter+ALU. For the instructions not requiring Shift operation, the instruction is able to go directly into AU or LU to perform and complete operations in a shorter period of time. Except the Data Processing instructions, almost all the Load/Store instructions can be changed from executing Shifter+ALU to executing AU, to achieve better effect of shortened cycle time.

2. Simplify the Frequently Utilized Operation Units:

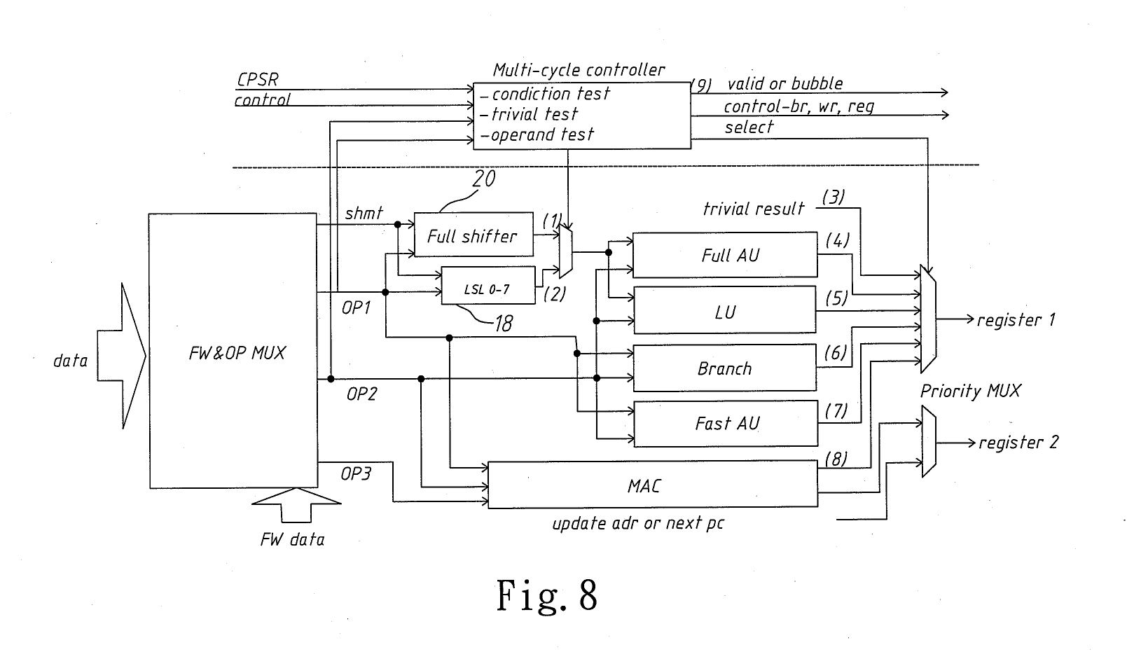

Refer to FIG. 8 for a circuit diagram of execution stage restructuring a variable delay path according to the present invention. As shown in FIG. 8, two examples are described. Wherein, in one example, a simpler shifter is provided (having only logic left shift function, with left shift amount not exceeding 7 bits “LSL 0-7), to eliminate 50% instructions that have to run on the original Shifter, so that the instruction execution time is faster by 1× folds than the original Shifter. The addition of LSL 1-7 could make the operations of the original shifter to require a little more time. Also, a multiplexer is added to select the data path, yet this would only affect slightly. In the other example, a simplified fast arithmetic unit (AU) is provided (the Fast AU only processes Addition and Subtraction not requiring changing flags), so that 40% instructions can be executed in a short period of time (part of the operations and load/store instructions).

3. Organization of Multiplexer and Data Path:

An appropriate data path planning is able to avoid continuous and overly long data transfer, to shorten the execution time. The strategy of the present invention is to parallelize the operations based on the various characteristics of the various operations. In this approach, the synthesis method mentioned above can be used to definitely optimize certain shorter data paths. Also, through parallelizing various operation units, the execution time could have a more uniform performance. In addition, a multiplexer having priority can be used to shorten the operation time.

4. Partial Result:

The valid output of execution stage is determined based on the type of instructions and data executed, that means the valid result can be obtained without the need to wait for all the signals are stabilized. By way of example, the multiplier (MAC 32×32+64) has the longest execution time. However, when the instruction executed is 8×8 (25% of MAC instructions), only 16 lowest bit (LSB) is the valid output result; while for a 8×16 (27%) valid output result, only 24 LSBs are required. By way of another example, when executing instructions without having to change status flag (CPSR register), then the result of “NZCV” is invalid. To the “MAC” instruction, for only obtaining the output result of the portion required, the execution time can be shortened by 30% to 50%. Also, to the “Full AU” instruction, the same approach is used, to shorten the execution time by 30%.

5. Trivial Result:

The results of certain instructions can be inferred simply based on operand without having to go through the operations, such as 0 used in addition, for any number added 0 is equal to its original value. In this approach, based on simple detection rule (a+0, a−0, a*1, and a*0), the results of simple operation can be obtained without going through operation unit, such that the result can be output to the next stage directly in a very short period of execution time.

6. Non-Commit Instruction:

Since the abandoned instruction “condition test fail” is also a short instruction, such that the result of operation need not to be committed, and the length of the execution time depends on the operation time of “condition-test”.

Finally, refer to FIG. 8 and Table 3 below as to how to restructure the execution stage based on instruction level. Based on FIG. 8, some of the frequently used data paths may have very short execution time. Through “the pipeline restructuring technology”, some corrections are made to the execution stage circuit, and the operation units of “logic shift left 0-7 (LSL0-7)18”, and Fast Arithmetic Unit (Fast AU) 20 are added, hereby providing a fast channel for specific instructions to pass through, raising the accuracy of predicting instruction execution time, and the system performance.

TABLE 3

| Throughs | | |
|---|---|---|
| points | Constraint data-paths | Related instructions |
| →(1)→(4) | shifter + Full AU(with or | arithmetic; load/store |
| | without flag update) | with shifter |
| →(2)→(4) | LSL 0-7 + Full AU(with or | load/store with shifter |
| | without flag update) | |
| →(1)→(5) | Shifter + LU | logic |
| →(2)→(5) | LSL 0-7 + LU | Logic |
| →(6) | Branch | Branch |
| →(7) | Fast AU | (arithmetic w/o shifter and |
| | | flag update); (load/store |
| | | w/o shifter) |
| →(8) | MAC(8 × 8, 16 × 8, | multiplier with different |
| | 16 × 16, 32 × 32) | operand-width |
| →(3)&→(9) | trivial result selection & | trivial result and |
| | multi-cycle controller | abandoned instruction |

Summing up the above, in the present invention, a vanguard mechanism for setting up variable cycles and a rearguard mechanism for detecting timing error are provided, to increase data throughput and reduce power consumption of a processor.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A dynamic scaling processor device, comprising:
a timing decoder, provided with a plurality of cycles therein, receiving a plurality of instructions to select corresponding cycles as its predetermined cycles based on type of each instruction, and outputting said predetermined cycles and its corresponding instructions;
a multi-cycle controller, connected to said timing decoder, and receiving said instructions and said predetermined cycles, said multi-cycle controller performs said instructions and outputs its results, based on said predetermined cycles or a single cycle; and
an error detection flip-flop connected to said multi-cycle controller to receive said result, a first clock signal, and a second clock signal lagging behind half a cycle, said error detection flip-flop utilizes said first clock signal and said second clock signal, to sample a same result, and correct said result when outcomes of samplings are different.

2. The dynamic scaling processor device as claimed in claim 1, wherein said multi-cycle controller further includes a finite state machine (FSM), connected to said timing decoder and said correction flip-flop, said finite state machine (FSM) receives said instructions and said predetermined cycles, to perform said instructions based on said predetermined cycles or said single cycle, and output its result.

3. The dynamic scaling processor device as claimed in claim 1, wherein said timing decoder further includes a plurality of registers, to store said cycles for external corrections required.

4. The dynamic scaling processor device as claimed in claim 1, wherein said multi-cycle controller utilizes a plurality of operation units respectively, to compute said result based on said single cycle.

5. The dynamic scaling processor device as claimed in claim 4, wherein said operation unit is an arithmetic logic unit (ALU).

6. The dynamic scaling processor device as claimed in claim 1, wherein said multi-cycle controller simplifies said plurality of operation units, to compute said result using said single cycle.

7. The dynamic scaling processor device as claimed in claim 6, wherein said operation unit is a shifter or an arithmetic unit (AU).

8. The dynamic scaling processor device as claimed in claim 1, wherein said multi-cycle controller parallelizes operations of said various operation units, and it utilizes a multiplexer to compute said result using said single cycle.

9. The dynamic scaling processor device as claimed in claim 1, wherein said multi-cycle controller fetches a part of operation results of said instruction, to eliminate unnecessary operations of said instruction and non-committed instructions, to compute said result using said single cycle.

10. A dynamic scaling processing method, comprising following steps:
receive a plurality of instructions, to select corresponding cycles as its predetermined cycles based on type of each instruction, and output said predetermined cycles and its corresponding instructions;
utilize a multi-cycle controller to receive said instructions and said predetermined cycles, to determine whether to execute a fast channel based on computed value of said instructions;
if yes, use a single cycle to perform said instructions to obtain a first answer; and
if no, use said predetermined cycles to perform said instructions to obtain a second answer;
utilize said first answer or said second answer as a result of performing said instruction, and output said result; and
receive said result, a first clock signal and a second clock signal lagging behind half a cycle, utilize said first clock signal and said second clock signal to sample a same result, and correct said result when outcomes of samplings are different.

11. The dynamic scaling processing method as claimed in claim 10, wherein in said step of using said single cycle to perform said instructions to obtain said first answer, a plurality of operation units are utilized respectively, to compute said first answer using said single cycle.

12. The dynamic scaling processing method as claimed in claim 11, wherein said operation unit is an arithmetic logic unit (ALU).

13. The dynamic scaling processing method as claimed in claim 10, wherein in said step of using said single cycle to perform said instructions to obtain said first answer, said plurality of operation units are simplified, to compute said first answer using said single cycle.

14. The dynamic scaling processing method as claimed in claim 13, wherein said operation unit is a shifter or an arithmetic unit (AU).

15. The dynamic scaling processing method as claimed in claim 10, wherein in said step of using said single cycle to perform said instructions to obtain said first answer, operations of said plurality of operation units are parallelized, and a multiplexer is utilized, to compute said first answer using said single cycle.

16. The dynamic scaling processing method as claimed in claim 10, wherein in said step of using said single cycle to perform said instructions to obtain said first answer, a part of operation result is fetched, and unnecessary operations of said instructions or non-committed instructions are eliminated, to compute said first answer using said single cycle.
